(19) United States
(12) Patent Application Publication
(10) Pub. No.: US 2006/0195837 A1
(43) Pub. Date: Aug. 31, 2006

(54) Synchronized-download version manager (S-DVM)

(75) Inventor: Aaron Fessler, Mendham, NJ (US)

Correspondence Address: VENABLE LLP, P.O. BOX 34385, WASHINGTON, DC, 20045-9998, US

(73) Assignee: Safenet, Inc., Belcamp, MD (US)

(21) Appl. No.: 11/363,543

(22) Filed: Feb. 28, 2006

Related U.S. Application Data
(60) Provisional application No. 60/657,173, filed on Feb. 28, 2005.

(51) Int. Cl. G06F 9/44

(52) U.S. Cl. 717/170; 717/175

(57) ABSTRACT

A Synchronized-Download Version Manager (S-DVM) allows media creators to take advantage of the valuable attributes embedded in a media file because it provides the ability to not only download and identify the different media versions that pervade the Internet, but it also enables the analysis, investigation, and tracking of each of the attributes embedded in the file, attributes which can help in the tracing of distribution leaks, master file theft, and file propagation.

This patent application claims priority to U.S. Provisional Patent Application Ser. No. 60/657,173, entitled “Synchronized-Download Version Manager (S-DVM),” filed Feb. 28, 2005, which is incorporated herein by reference in its entirety.

### BACKGROUND OF THE INVENTION

1. Field of the Invention

The present invention relates generally to systems, methods, apparatus, and computer-readable media to control distribution leaks, master file theft, and file propagation. More specifically, a synchronized-download version manager (S-DVM) is disclosed, which not only allows media creators to take advantage of the valuable attributes embedded in a media file because it provides the ability to not only download and identify the different media versions that pervade the Internet, but it also enables the analysis, investigation, and tracking of each of the attributes embedded in the file, attributes which can help in the tracing of distribution leaks, master file theft, and file propagation.

2. Related Art

Presently, the Internet enables users all over the world to share and exchange all types of digital media, such as books, audio, images, movies, games, software, etc. The ability to share and exchange digital media, although useful in the appropriate context, has given rise to infringement of copyrighted material for personal use, illegal distribution, and unwanted manipulation. The current rate of copyright infringement on the Internet, be it through the use of peer-to-peer (i.e., P2P) networks, FTP (i.e., file transfer protocol) or NNTP (i.e., network news transfer protocol) sites, IRC (i.e., Internet relay chat) networks, or any other means of sharing copyrighted content, demands that those companies or individuals who have created media for the purchasing public's use, which are widely available to anyone on the Internet, must employ methods to protect their copyrighted works from infringement.

Many different strategies have been proposed and employed in order to reduce the problems of distribution leaks/theft and copyright infringement, and there are a number of identifying attributes that can be used in order to trace a distribution leak to its originating source. One approach, which has proven effective in securing copyrighted materials and providing information for investigation, is digital watermarking combined with digital fingerprinting.

When creating media, movie studios, record companies, software companies, etc., typically create between 5 and 15 original versions while a subsequent 10 to 30 promotional copies are made for a number of purposes. Movie studios often make promotional copies for exhibitors (e.g., U.S. theaters), reviewers, producers, DVD pressing, VHS taping, and hospitality. Hotels, for example, offer movies for pre-release viewing. Each of those copies is susceptible to theft and vulnerable to leakage, copying, or manipulation. When someone (or some group), who has stolen, leaked, copied, or manipulated copyrighted media, propagates that media over the Internet and/or distributes that media through physical distribution channels many challenges arise which media creators must overcome in order to mitigate the impact to their business. These challenges, if not overcome will foster continued and rampant file propagation and copyright infringement. The challenges posed by the illegal propagation of infringing content include the following.

Thousands of propagated copies of infringed content on the Internet complicate any form of analysis as to the identification of the origin of the leak or theft.

In order to pursue investigation efforts, copies of the infringed content must be obtained to take advantage of the valuable attributes (e.g., watermarks, fingerprints, metadata, quality, file size, file name, etc.), which are embedded into each propagated copy of infringed content.

Collaboration is necessary between multiple parties (e.g., 3^{rd} party vendors such as digital watermark vendors, content solution providers, film/digital forensic specialists, etc.) who are often located in multiple locations across the world.

The large file sizes of the propagated copies inhibit the efficient investigation of infringed content due to difficulties in transferring media files between parties and storing media files for review.

The inability to track and report on the propagated files and related investigation activities

Without a solution that can surmount the aforementioned obstacles, the content creator's efforts to secure their content through the process of embedding watermarks in their master files are ineffective as shown as an exemplary diagram in FIG. 1.

### SUMMARY OF THE INVENTION

A synchronized-download version manager (S-DVM), according to embodiments of the present invention, provides the media creator with the ability to use attributes that are embedded into a media file, so that they may trace distribution leaks, thwart and identify master file theft, and group millions of propagated media files into manageable versions. The S-DVM meets the media creator's media content protection needs by performing the following essential functions: scanning and investigation, downloading, versioning, synchronization of media files to various parties, and reporting/analysis. Specifically, it identifies media files that have been propagated on the Internet by leveraging an investigation platform which scans the entire Internet for selected media titles. The S-DVM's scanners collect data from FTP sites, HTTP sites, NNTP sites, and P2P networks for specified media titles in an effort to identify all of the media files available for the specified media title. The S-DVM solution carefully analyzes the relevant information regarding each media file in order to categorize each media file into unique versions. The unique versions are then further grouped to typically 4-8 unique leak sources through a complex data-mining process. Unique versions of media files for a specified media title are downloaded from the Internet and distributed for local access and efficient access by a geographically dispersed workforce. Once this process is completed, the media creator's anti-piracy workforce is able to conduct their investigation activities more efficiently through the use of the S-DVM solution.

In an exemplary embodiment of the present invention, the S-DVM comprises a method by which hundreds of thousands of media files, which are virally propagated on the Internet as shown in FIG. 2, may be efficiently and accurately linked to unique leak sources in order to allow media creators to effectively perform anti-piracy forensics investigation work. Upon linking these propagated media files to a unique leak source, media creators may be able to better measure the financial impact of each media leak, to better measure the impact each leak has on distribution and supply, to increase the value of the watermarking and digital fingerprinting process, to keep abreast of digital rights management (i.e., DRM) vulnerabilities and potential enhancements, to improve their forensics investigation efforts, and to ultimately identify and stop the illegal distribution of copyrighted content.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts a block diagram illustrating how, in the prior art, a watermarked and/or a fingerprinted master media file can be compromised and propagated on the Internet and how a watermarked media file may, despite its propagation on the Internet, reveal much about the origin of the media file;

FIG. 2 depicts a schematic showing the complexity of any form of analysis as to the origin of the master version leak or theft because of the sheer number of the and the various locations of each file; it also depicts how master media files may be leaked from specified media distribution sources;

FIG. 3 depicts an eight-step synchronized-download version manager process which may be used in accordance with the present invention to successfully locate, categorize, distribute, manage, and report on pirated media files;

FIG. 4 depicts a block diagram showing the flow by which S-DVM scanners according to the present invention may scan the Internet;

FIG. 5 is a schematic diagram depicting how the S-DVM's version manager according to the present invention is able to categorize the records from traded files, which have been parsed from logs that the S-DVM's scanners have captured, into versions according to the present invention;

FIG. 6 depicts the automated download and distribution system (ADS) according to the present invention;

FIG. 7 depicts an exemplary flowchart that shows the process that an S-DVM user goes through when logging onto the S-DVM's secure FTP site;

FIG. 8 depicts an exemplary flowchart showing the process the ADS undertakes when synchronizing media versions;

FIG. 9 depicts an exemplary flowchart of a reporting service according to the present invention; and

FIG. 10 depicts the flow of version information from media creators and 3^{rd} party vendors to the reporting service shown in FIG. 9, as well as the architecture of that reporting service.

### DETAILED DESCRIPTION OF EMBODIMENTS OF THE PRESENT INVENTION

Exemplary embodiments of the invention is discussed in detail below. While specific exemplary embodiments are discussed, it should be understood that this is done for illustration purposes only. A person skilled in the relevant art will recognize that other components and configurations can be used without parting from the spirit and scope of the invention.

For the purposes of the following discussion, the following terms may have the following meanings.

A “computer” may refer to any apparatus that is capable of accepting a structured input, processing the structured input according to prescribed rules, and producing results of the processing as output. The computer can include, for example, any apparatus that accepts data, processes the data in accordance with one or more stored software programs, generates results, and typically includes input, output, storage, arithmetic, logic, and control units. Examples of a computer include: a computer; a general purpose computer; a supercomputer; a mainframe; a super mini-computer; a mini-computer; a workstation; a micro-computer; a server; an interactive television; a web appliance; a telecommunications device with Internet access; a hybrid combination of a computer and an interactive television; a portable computer; a personal digital assistant (i.e., PDA); a portable telephone; a smartcard, a processor-based token; and application-specific hardware to emulate a computer and/or software. A computer can be stationary or portable. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” may refer to any storage device used for storing data accessible by a computer. Examples of a computer-readable medium include: a magnetic hard disk; a floppy disk; an optical disk, such as a CD-ROM or a DVD; a magnetic tape; a memory chip; a universal serial bus (i.e., USB) token; and a carrier wave used to carry computer-readable electronic data, such as those used in transmitting and receiving e-mail or in accessing a network.

A “media file” may refer to any electronic form or digital representation of a copyrighted work, including motion pictures, music (e.g., songs or albums), television (e.g., show or series), business software, entertainment software (e.g., PC game and/or console games), publishing, etc., which (a) is stored within a computer-readable medium; or (b) resides on the Internet or on a CD/disk; or (c) is transmitted as a digital file via email, a peer-to-peer network, and HTTP (i.e., hypertext transfer protocol) site, and NNTP (i.e., network news transfer protocol) site, an FTP (i.e., file transfer protocol) site, or a P2P (i.e., peer-to-peer) network; or (d) any equivalent of the foregoing.

A “media title” may refer to any titled or named copyrighted media file produced by a media creator for release and sale.

A “media creator” may refer to the author or creator of media content, the rightful owner of the copyrighted media content, or the copyright holder for the media content.

A “unique version” may refer to a grouping of similar or identical media files that may be traced back or originate from one unique master file. A unique version is the version from which a certain portion or all propagated media files for a specified media title may have derived.

A “third party vendor” (or “3^{rd} party vendor”) may refer to any vendor, specialist, or company a media creator may enlist in order to help with its media file identification, anti-piracy management, watermark methods/deciphering, digital rights management, etc.

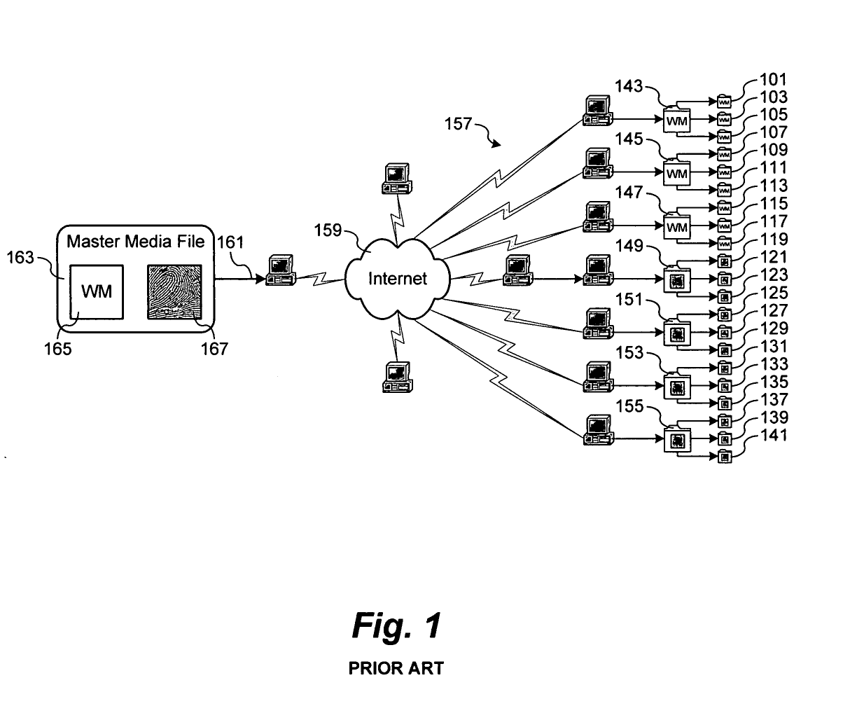

FIG. 1 illustrates how, in the prior art, a watermarked 165 and/or a fingerprinted 167 master media file 163 can be compromised and propagated on the Internet and how a watermarked media file may, despite its propagation on the Internet, reveal much about the origin of the media file. The media files labeled 101-141 show how many copies of one media version can be propagated across the Internet 159. Files 101-105 are just a few of the copies that could be made from file “version 1” 143, but those three copies 101-104 all bear an embedded digital watermark 167 from the version 1 from which they were created. That version I can be traced all the way back to the master file 163 which can then be traced back to the author/creator of the media, the version's time of creation, the reason for the version's creation, the originator of the version, etc. At the same time, a version's embedded digital fingerprint 167 as shown in “version 4” 149, which is identical to other “versions 5-7” 151, 153, 155 of the specified title, yet unique to the specific version, may enable 3^{rd} party vendors to authenticate and identify information about the version should they have the proper mechanism to attain those media versions. Each version copy (copies 101-141) bears a digital fingerprint that can be traced back to a media version fingerprint 167, and it is that unique yet identical fingerprint that may be able to answer the file creation questions which the media creator needs answered in order to accomplish its anti-piracy objectives.

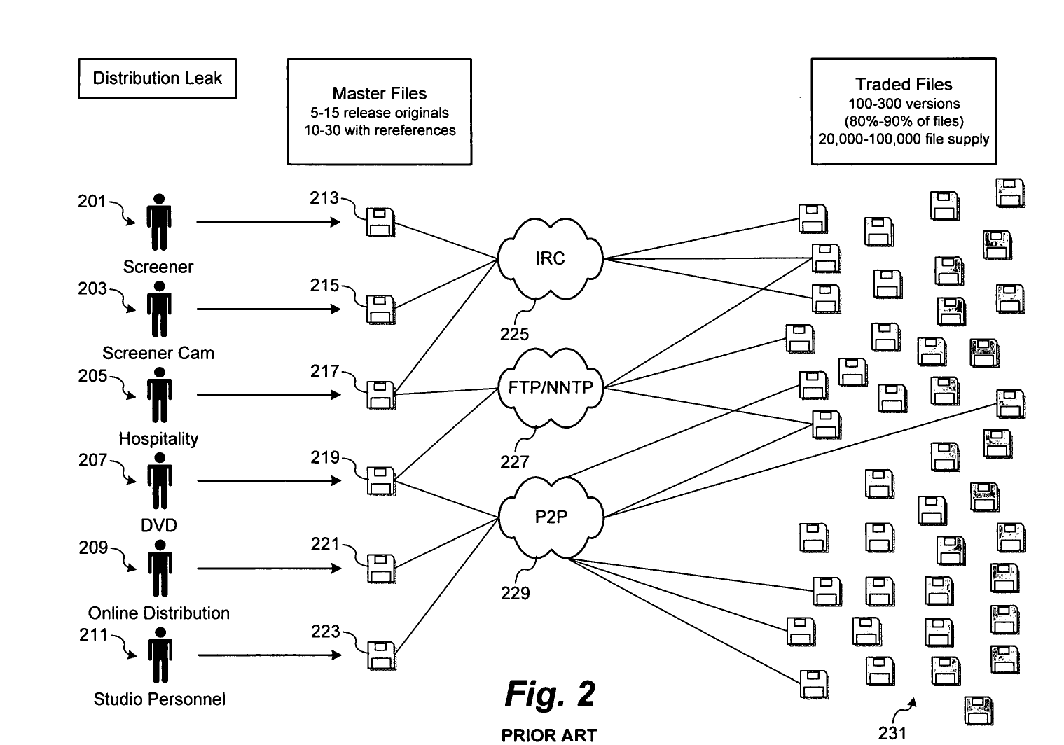

FIG. 2 shows how the thousands of propagated copies or traded files 231 of the master files 213-223 that pervade the Internet and are physically sold or distributed across the world complicate any form of analysis as to the origin of the master version leak or theft because oft eh sheer number of the and the various locations of each file 213-223. FIG. 2 also depicts how master media files are leaked from specified media distribution sources. Upon creating between 5 and 15 master media files, media creators typically distribute these master files into the hands of a number of important players (201-211). In the case of movies, movie studios send master files out to Screeners 201, who in turn review and critique the movie; to hotels 205, who offer pre-released movies as a show of hospitality to their guests; to DVD pressing companies 207, who use an original master file to press millions of copies; to online distribution companies 209, who will distribute the digital file to consumers for a price; and to studio personnel 211, who will review the movie or clips of the movie for marketing purposes, business purposes, etc. When master files 213-223 are in these various locations, they are susceptible to theft, leakage, copying, or manipulation. Upon being stolen, leaked, copied, or manipulated, these master media files 213-223 can make their way onto the streets of cities across the world or the Internet, where they may be offered from various sites such as IRC (i.e., Internet Relay Chat) 225, FTP (i.e., file transfer protocol)/NNTP (i.e., network news transfer protocol) 227, or P2P (i.e., peer-to-peer) networks 229. Upon being offered on any of these three sites 225-229, the master files can be propagated on the Internet and thousands of versions of the original master files may appear in the form of traded files 231.

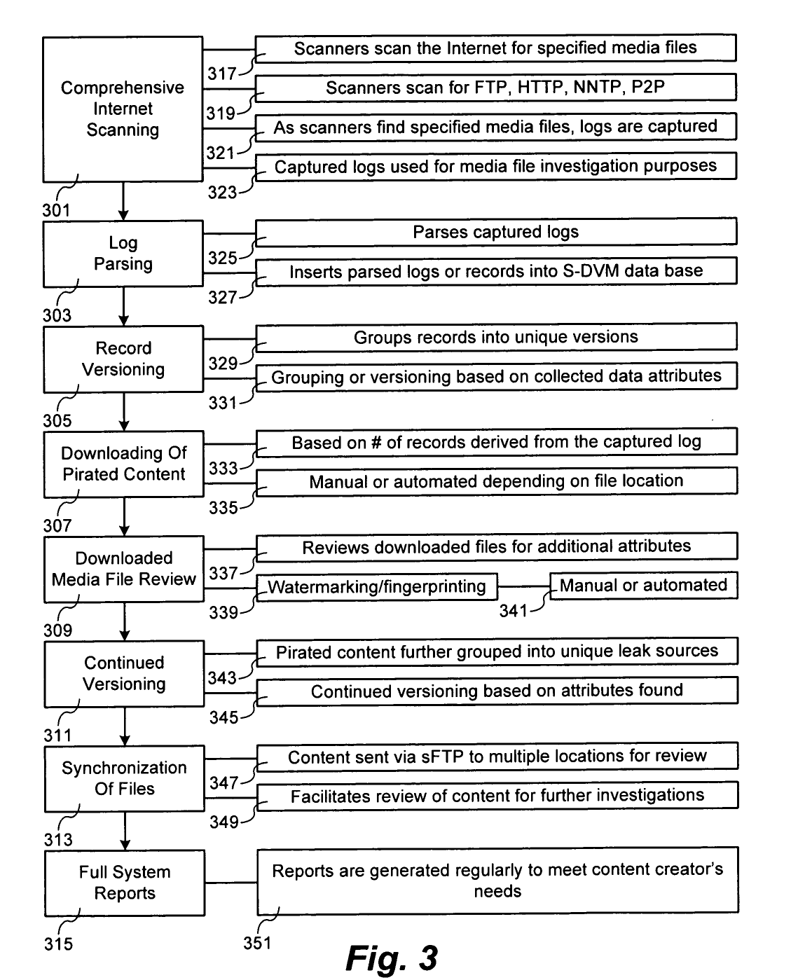

As shown in FIG. 3, the eight-step S-DVM solution may be made up of the following process to successfully locate, categorize, distribute, manage, and report on pirated media files.

Step 1 is a comprehensive scanning of the Internet for specified media titles leveraging the S-DVM's scanners. These scanners scan FTP, HTTP, and NNTP sites, and P2P networks for specified media titles. As scanners find media files for a specified media title, logs containing a comprehensive set of data attributes required for investigation are captured.

It begins when the S-DVM's scanners are given a media title to search for on the Internet at 301. The S-DVM's scanners scan the Internet for media files the match up with the specified media title 317. Specifically, the scanners work their way through FTP, HTTP, and NNTP sites, and P2P networks 319 and as the scanner(s) find media files that match the specified media title, the scanners capture logs 321 that will be used for media file investigation and the grouping of unique versions 323.

Step 2 is a process by which the captured logs are parsed and inserted as records into the S-DVM database. When the logs for a specified media title are forwarded to the S-DVM's central server, the log parsing begins at 303. The S-DVM will parse the logs 325, and insert the parsed logs (i.e., called records) into the S-DVM database at 327.

Step 3 is a process run against those records, which groups them into unique versions of pirated content based on a subset of the data attributes collected. This third step in the S-DVM process begins with record versioning at 305, where the S-DVM groups the parsed records into unique versions at 329 based on the collected data attributes 327.

Step 4 is the process by which the pirated content is downloaded for the versions with the most records associated. Depending on the protocol where the pirated content is located, either an automated or manual process is initiated. When an automated process is initiated, a request is queued for a scanner to download the pirated content. When a manual process is initiated, a request is queued for an assigned staff member to retrieve the pirated content.

If pirated content is found when reviewing the unique versions, the pirated content—or the actual media files—will be downloaded at 307 based on the number of records derived from the captured logs at 333. The downloading of the pirated content—or the actual media file—may be either manually downloaded or automatically downloaded depending upon the file location at 335, and the ease with which it may be obtained.

Step 5 includes the review of the downloaded files for additional unique identifiers. These unique identifies are logged as data attributes. The review process can take on many forms, either through the use of watermarking or fingerprinting decoding technologies or a manual process to identify watermarks placed intentionally or unintentionally.

Once the media file is downloaded, it is reviewed at 309 for additional data attributes 337 and for digital watermarks or digital fingerprints 339; as selected at 341, these reviews may be done automatically by the S-DVM or manually by an S-DVM technician or by the media creator and any 3^{rd} party vendors.

Step 6 is a process by which the versions that represent up to 95 percent of total pirated files identified are further grouped into unique leak sources based on the additional unique identifiers captured during step 5.

As the media files are being reviewed, the S-DVM continues to group pirated content—or media files—by unique versions at 329, those versions that are identified as pirated content further grouped into unique leak sources 343 as they make their way around from media creator to any 3^{rd} party vendors and as attributes are identified (some from the previous review) throughout the S-DVM process, they are taken into account when versioning the pirated content and determining unique leak sources 343.

Step 7 is a process where the downloaded pirated media files are synchronized across servers located within the local area networks of the media creator and any various 3^{rd} parties. This step facilitates the efficient review of the pirated content for further investigations efforts.

When the S-DVM's Version Manager has fully tagged the identified attributes and has completed all of the versioning it is able to accomplish with its established resources, the downloaded media files are synchronized across multi-locations for further review at 313. The S-DVM allows and expects media creators and any 3^{rd} party vendors who might have a hand in the production, protection, and distribution of media content to collaborate in the process of determining unique version and identifying unique leak sources. The S-DVM permits downloaded content to be sent via a secure FTP (i.e., sFTP) site to various locations for further review at 347, facilitating the continued review of downloaded media files for further piracy investigation.

Step 8 is a set of reporting and analytical processes which are run on various daily, weekly, and monthly frequencies in order to provide comprehensive reporting and analysis.

Upon finalizing the review of the multiple media version/pirated media files for a specified media title, the S-DVM will allow the media creator and any 3^{rd} party vendors to generate full system reports at 315, specifically they will be able to generate reports/analysis on a regular basis to meet their specified needs 351.

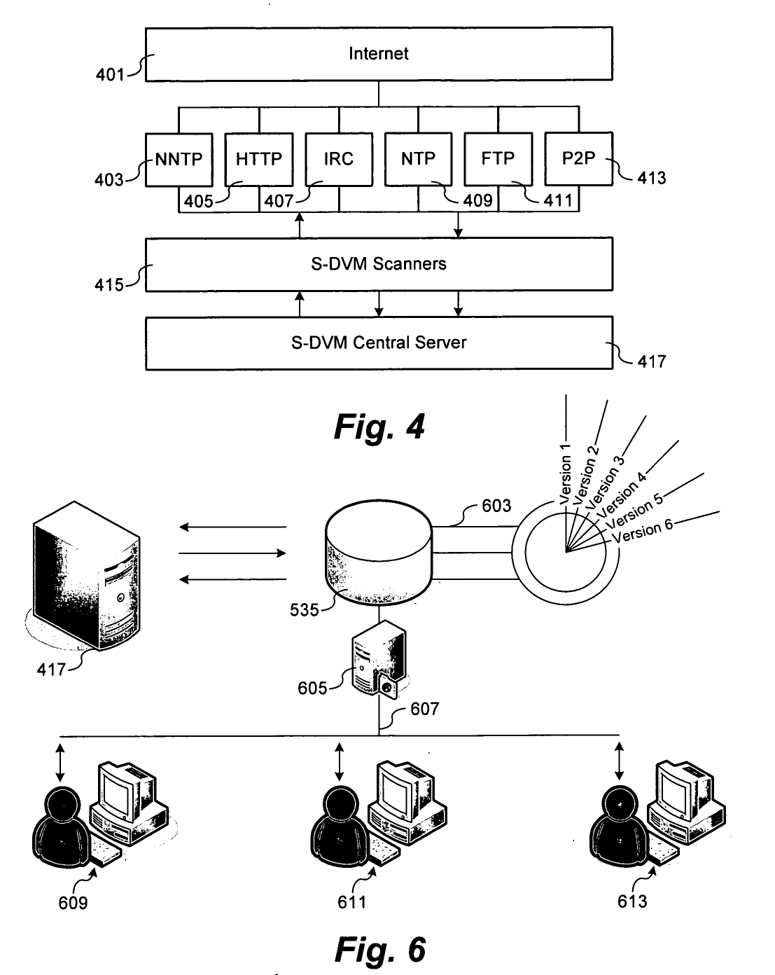

As previously mentioned, the S-DVM solution meets the business objectives by performing the following essential functions: scanning and investigation, downloading, versioning, synchronization of files to various parties, and reporting/analysis, and these S-DVM functions are accomplished by the components shown in FIG. 4.

FIG. 4 shows the flow by which the S-DVM scanners 415 scan the Internet 401, specifically: NNTP 403, HTTP 405, IRC 407, NTP (i.e., Network Time Protocol) 409, FTP 411, and P2P 413 for specified media titles. Upon finding media files for the specified media title, the S-DVM scanners 415 capture logs from those media file. Those logs are then passed and inserted as records into the S-DVM's central server 417. The S-DVM database then groups those records into versions at which point the S-DVM's central server 417 authorizes the downloading of media files based on the finding of pirated content. The S-DVM's central server 417 then asks the S-DVM's scanners 415 to begin the process by which the pirated content is downloaded from the Internet 401 for the version with the most infringing records associated with it.

With one or more scanners based in one location or in a plurality of locations as seen in the scanners in FIG. 4, the S-DVM can scan the Internet for specified media titles. Specifically, these scanners are searching peer-to-peer networks (e.g., Fasttrack, BitTorrent, eDonkey, etc.), IRC networks, FTP sites, HTTP sites, and a significant number of newsgroups and for media files based on the media title which a media creator may specify specifies. Upon completion of the search, logs are captured of the findings, parsed and loaded into the S-DVM database as individual records of identified pirated content. The infringing records are categorized by version using the version manager based on the data attributes collected in the logs. A request to download the pirated content is initiated to the scanners for the versions with the most records associated. The scanners then download a sample of each version of pirated content requested. Versions that the scanners are unable to download are submitted to a queue for manual download. The downloaded pirated content is then stored in the S-DVM's central server 417.

The S-DVM's scanners may also scan auction sites, web sites, email messages/solicitations etc. for hard goods infringements of media files. Upon detecting hard goods infringements of media files, those hard goods would be sought after, attained, and uploaded manually to the S-DVM's central server 417 for versioning, synchronization, and reporting.

Depending upon the type of network the S-DVM's scanners 415 are searching, the approach the scanners may take in assessing the media files available for a specified media title may vary. For instance, searching for a file on a peer-to-peer network like KaZaA may require that the database interact with Fastrack (i.e., a peer-to-peer protocol, used by the KaZaA, Grokster, and iMesh file sharing programs, which has the ability to resume interrupted downloads and to simultaneously download segments of one file from multiple peers) through specified search functions and supemodes, while searching for a media file on a newsgroup or an FTP site is a matter of determining which newsgroup or FTP site is offering the file being searched for using information released in forums and various index sites.

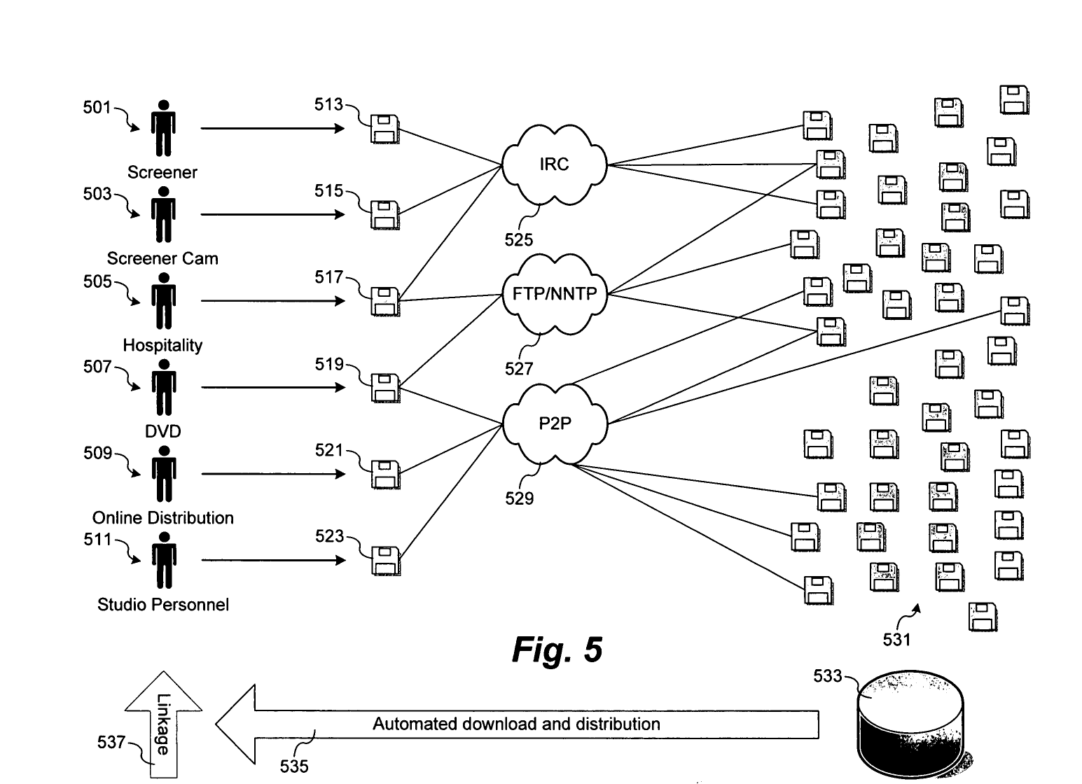

FIG. 5 is a diagram depicting how the S-DVM's version manager 533 is able to categorize the records from the traded files 531, which have been parsed from the logs that the S-DVM's scanners have captured, into versions, unique versions that can be traced back or linked to the original leak sources 501-511. Beginning with the distribution leaks 501-511, an original release 513-523 is distributed onto IRC 525, FTP/NNTP 527, or P2P 529 at which point the original release files are propagated as traded files 531 on the Internet. Without the S-DVM's version manager 533 to obtain the media file's records and version each based on the number of records found for a media file, a media creator's ability to acquire all the propagated illegal content on the Internet would be impossible.

The S-DVM's version manager 533 reduces the thousands of propagated media files found on the Internet or in the physical world for a specified media title into a number of unique versions based upon the information obtained from embedded file attributes. The version manager 533 is then able to categorize those unique versions, and archive those versions, so that they can be distributed to collaborative parties and used simultaneously by those parties to link versions found on the Internet with the distribution leaks as shown in FIG. 5. The S-DVM's version manager 533 may enable media creators and any 3^{rd} party vendors to tag attributes and track a large volume of versions. The version manager's robust archive database and advanced file server architecture allows many users synchronized access, common search capabilities, and attribute tagging functions. The version manager 533 protects against data corruption as the number of versions increase, and it allows the central server 417 to be in control of all versions even as they are distributed to various users.

The version manager 533 automatically tags the valuable attributes that are embedded in the various versions. Those versions with attributes that are unable to be assessed and tagged by the version manager 533 may be distributed by an Automatic Distribution System (ADS) 535 to the media creator and any 3^{rd} party vendors. The version manager 533 would then enable the media creator and any 3^{rd} party vendors to manually tag attributes and update any version information.

FIG. 6 shows that the S-DVM's Automatic Distribution System or the ADS 533 uses a secure FTP (sFTP) 605 to transmit 603 files to media creators 611 and any 3^{rd} parties 609, 613. As shown therein, this sFTP site 605 provides file and directory synchronization between the S-DVM's central server 417, the media creator 611 and any 3^{rd} party vendors 609, 613. The media creator's connection 607 to the sFTP site 605 is encrypted so that media file or version transfer is secure and efficient.

Upon downloading the pirated files in need of further tagging to their servers, media creators and any 3^{rd} party vendors may organize and manage their downloaded files using a specified S-DVM interface. As various users update information and manually tag attributes, the version manager 533 automates collaborative tagging and information-gathered via the sFTP server 605 of the ADS 535, which enables parallel/synchronized version updates and prevents lost changes, unintentional overwrites, and tagging errors.

Once the copies of pirated content have been downloaded, the files are reviewed for unique identifier either through watermarking or fingerprinting technologies or through manual review methods. After review of the pirated copies based on the additional data attributes are collected and recorded in the database an additional process occurs, so that versions can be further regrouped into the unique leak sources. Often, there will be 5-10 unique leak sources spanning approximately 100 versions which represent 95% of all pirated content found.

Synchronization may play a significant role in the S-DVM's version managing and reporting functions, and it is the ADS 535 which synchronizes all downloaded pirated media files, so that media creators and any 3^{rd} party vendors can collaborate in the attribute tagging process as shown in the exemplary ADS process shown in FIG. 6. The S-DVM is able to complete its collaboration objectives because it is able, through the ADS, to synchronize data across a multi-location environment. Media creators and any 3^{rd} party vendors at various locations can see the data they request in real time, and tagged attributes and version corrections are updated in each version on the central server in real time.

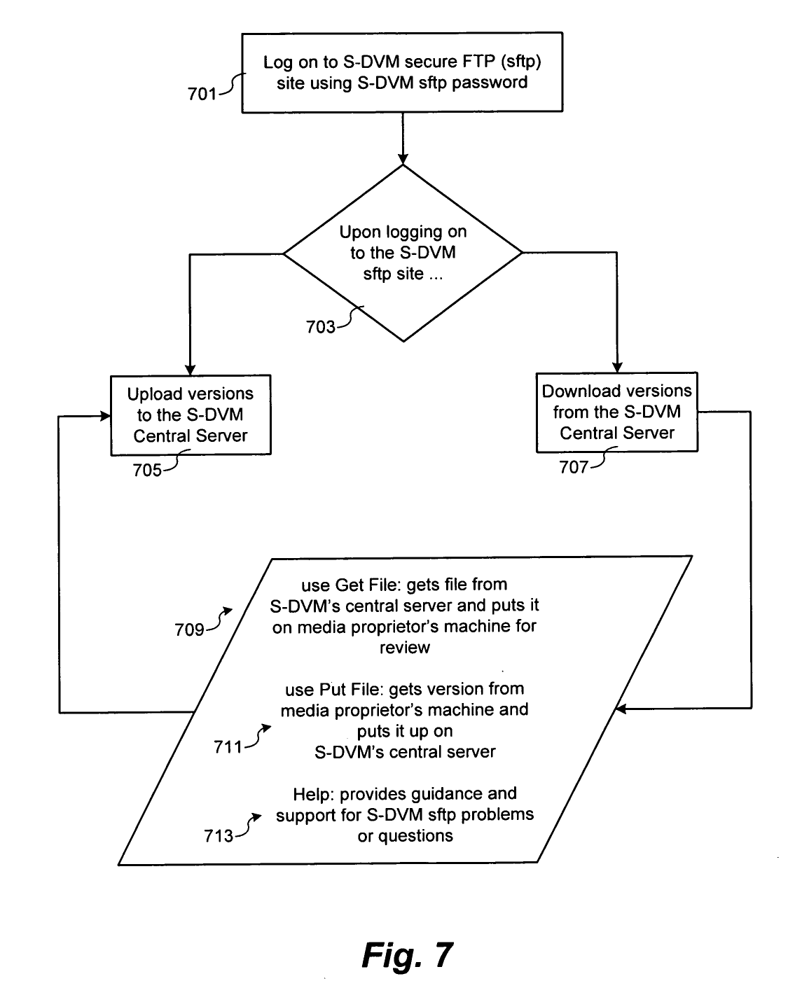

FIG. 6 also shows that the ADS uses a secure file transfer protocol (sFTP) server 605 to transmit files to media creators and any 3^{rd} parties in the manner shown in FIG. 7. FIG. 7 is an exemplary flowchart that shows the process that an S-DVM user goes through when logging onto the S-DVM's secure FTP site at 701. The user must do so using their sFTP password. Upon logging onto the S-DVM's sFTP site at 703, the user has two options 705 or 707. The user can either upload versions to the S-DVM's central server 417 at 705, or download versions from the S-DVM's central server 417 at 707. When logged onto the S-DVM's sFTP site, the user may use three commands that will enable them to download and upload information, and those commands are: (a) Get File 709, which allows the user to obtain a version from the S-DVM's central server 417 and put it on their computer for review; (b) Put File 706, which allows the user put a version they have been tagging up onto the S-DVM's central server 417 for further version categorization; and (c) Help 707, which provides guidance and support for any sFTP problems or questions.

FIG. 7 also details the process for uploading information onto an sFTP server 605 and downloading information from an sFTP server 605. sFTP server 605 may be a special auxiliary tool to OpenSSH, which stands for Open Secure Shell, and is a set of computer programs providing encrypted communication sessions over a computer network. It allows people to make FTP-like connections to an OpenSSH server and carry out secure encrypted file transfers.

As shown in FIG. 6, this sFTP site 605 provides file and directory synchronization between the S-DVM's central server 417, the media creator 609 and any 3^{rd} party vendors 611, 613. The media creator's connection to the sFTP site 605 is encrypted so that media file or version transfer may be secure, protecting the media creator's password and downloads from being intercepted by outside parties.

The steps the ADS 535 takes in downloading from its secure FTP site are shown in the exemplary flowchart of FIG. 7. When an S-DVM user logs onto the S-DVM's secure ftp site, the user must do so using their sFTP password. Upon logging onto the S-DVM's sFTP site, the user has 2 options: the user can either download files from the S-DVM's central server 417 or the user can upload samples of pirated content to the S-DVM's central server 417. When logged onto the S-DVM's sFTP site 605, they may use three commands that will enable them to download and upload information, and those commands are:

Get File: Get File allows the user to obtain a file from the S-DVM's central server 417 and putting on their computer for review.

Put File: allows the user to put a file they have tagged up onto the S-DVM's central server 417 for further version categorization.

Help: provides guidance and support for any sFTP problems or questions.

The S-DVM's use of an sFTP site may afford media creators and 3^{rd} party vendors (i.e., intended users) some important advantages over other modes of communication. First, the communication cycle as shown in FIG. 6 may be more efficient than other modes of communication. Broadcasting its encrypted data directly from the S-DVM's central server 417 and the multi-location users have to both be connected at the same time, and if a problem should occur at either end, the communication cycle would be broken, lessening the risk of data errors on either end of the communication cycle. Another important advantage in using an sFTP server is the amount of time a user's computer is online. With an sFTP server, the user may be able to download versions of media and view that media on their own computer, limiting the amount of online viewing time, which can be frustrating for the user, and costly as well. And finally, each user may store their media versions during their review process, meaning that intended users are not dependent on a continuous live connection to the Internet for their versions. In this way, users may view their versions in real time, review their versions, and tag their versions despite an Internet connection failure, and since the S-DVM's ADS 535 may be configured to synchronize versions to media creators and 3^{rd} party vendors at the most convenient intervals, the sFTP server may create the best of both worlds because versions can be updated often, and the media creator and 3^{rd} party vendors are not dependent upon a continuous Internet connection.

Functioning as a virtual mailbox for S-DVM users, media creators and 3^{rd} party vendors can connect to the sFTP server 605 and can download media versions there directly without any cross communication. Each user may then access the server at any time, download the versions that have been uploaded onto the sFTP server 605 directly from the S-DVM's central server 417 for review, and upload any version updates, tagged versions, or version corrections to the sFTP server 605 in order to update the central server 417 in real-time.

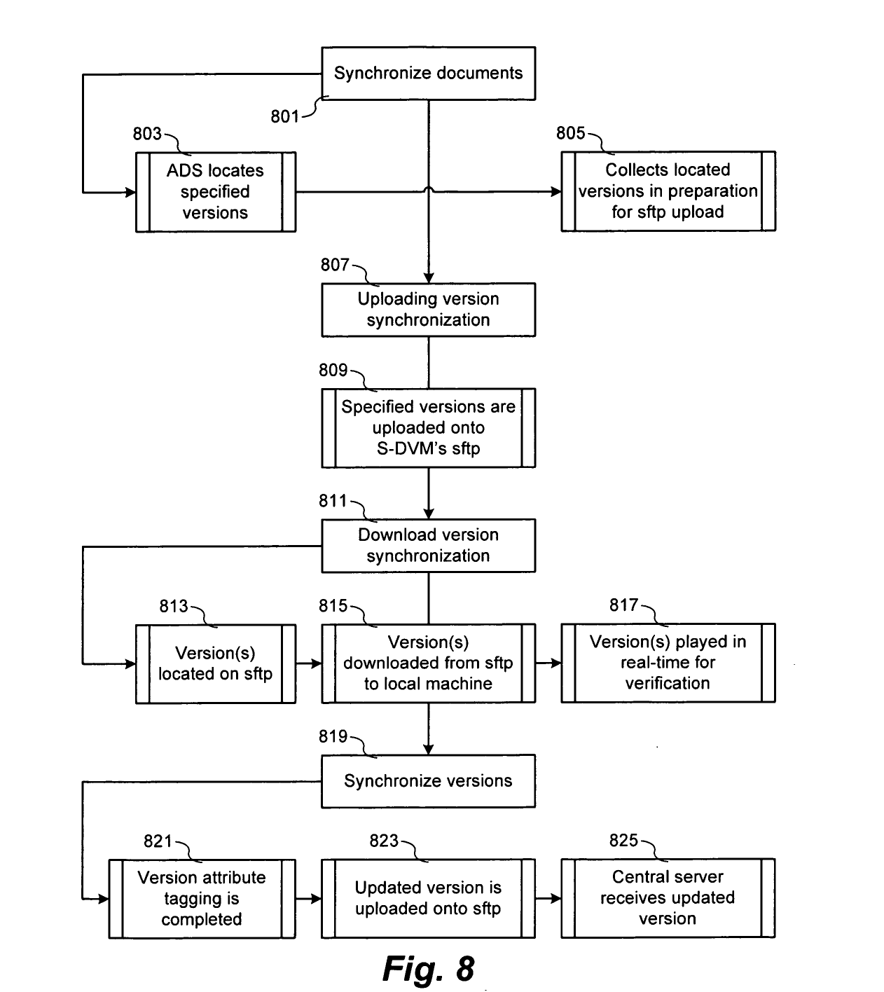

FIG. 8 is an exemplary flowchart showing the process the S-DVM's ADS 535 undertakes when synchronizing media versions. This process as seen in this diagram may be broken down into four basic steps 801, 807, 811, and 819. In step 801, documents are synchronized by the S-DVM in the ADS 535. The ADS 535 locates the versions specified at 803 by the media creator or any 3^{rd} party vendors and then collects those located versions at 805 in preparation for the central server's uploading of versions onto the sFTP server at 807. The ADS 535 does not harbor the versions on its own, but is able to retrieve versions from the S-DVM's central server 417 when requested to do so by the media creator or any 3^{rd} party vendors.

Step 807 is when versions are synchronized and uploaded onto the sFTP server at 809. Any specified versions are synchronized via the ADS 535 and uploaded onto the sFTP server 605, making the specified versions available to media creators and any 3^{rd} party vendors for download. The ADS synchronizes the version downloads in step 811, permitting media creators and any 3^{rd} party vendors access to versions for their review and attribute tagging purposes. In this step 811, any specified/requested versions are located on the sFTP at 813 by the intended user, those versions are downloaded from the sFTP onto the intended user's machine at 819, the version can then be played in real time for verification at 817, and the media creator and any 3^{rd} party vendors can continue the attribute tagging process, update any version information, and, if need be, further identify any current tagged attributes. The final step in the S-DVM's Automatic Distribution process is the synchronizing of versions at 819. Once the media creator and any 3^{rd} party vendors have completed their own attribute tagging at 821, they can upload the updated version onto the sFTP server at 823. Once the updated versions are uploaded onto the sFTP server at 823, the ADS synchronizes the version and updates the Central Server with current tagged versions at 825.

For clarification, the process shown in FIG. 8 breaks down the ADS into what could be four basic steps. In step 1, documents are synchronized by the S-DVM in the ADS, the ADS locates the versions specified by the media creator or any 3^{rd} party vendors, and then collects those located versions in preparation for the central server's uploading of versions onto the sFTP server. The ADS does not harbor the versions on its own, but is able to retrieve versions from the S-DVM's central server when requested to do so by the media creator or any 3^{rd} party vendors. Step 2 is when versions are synchronized and uploaded onto the sFTP server. Any specified versions are synchronized via the ADS and uploaded onto the sFTP server, making the specified versions available to media creators and any 3^{rd} party vendors for download. The ADS synchronizes the version downloads in step 3, permitting media creators and any 3^{rd} party vendors access to versions for their review and attribute tagging purposes. In this step, any specified/requested versions are located on the sFTP by the intended user, those versions are downloaded from the sFTP onto the intended user's machine, the version can then be played in real time for verification, and the media creator and any 3^{rd} party vendors can continue the attribute tagging process, update any version information, and, if need be, further identify any current tagged attributes. The fourth and final step in the process is the synchronizing of versions. Once the media creator and any 3^{rd} party vendors have completed their own attribute tagging, they can upload the updated versions onto the sFTP server. Once the updated versions are uploaded onto the sFTP server, the ADS synchronize the version and update the central server with current tagged versions.

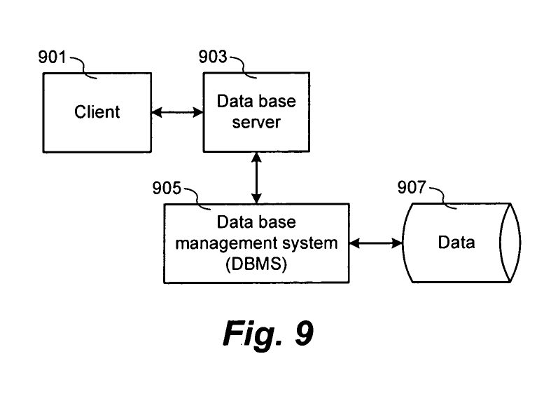

The S-DVM's fourth part is a comprehensive, a server-based reporting service that allows the S-DVM to deliver flexible and interactive reports on categorized versions to media creators and 3^{rd} party vendors. The S-DVM's reporting services enables media creators and any 3^{rd} party vendors to transform defined/tagged version attributes into shared data that is organized, informative, and usable. This reporting service is a comprehensive, server-based tool that may best be described by reference to FIG. 9.

FIG. 9 is an exemplary flowchart of a reporting service that consists of a client interface 901 whereby a user interacts with a data base server 903 in order to render data in a certain format, a data base server 903 which acts behind the scenes in order to correctly format user requested data for viewing, a data base management system (DBMS) 905 which enables a user to store, modify, or extract data, based on user queries, and a data mart or source 907 where raw, transaction-level data is stored waiting to be put to use.

The data base management system (DBMS) 905 may be a collection of programs that enable a user to store, modify, and extract information from a database. It may be necessary for this DBMS 905 to support fast aggregations in order to process complex queries and reduce poor response time. Server 903 in this reporting/analysis context may be a computer or device on a network that manages the database in such a way as to enable the transformation of data into reports and enables the management and delivery of paper-oriented reports, interactive reports, or web-based reports. And, the client application interface 901 may be an application that, rather than store data, will process data and present the data on a user's screen.

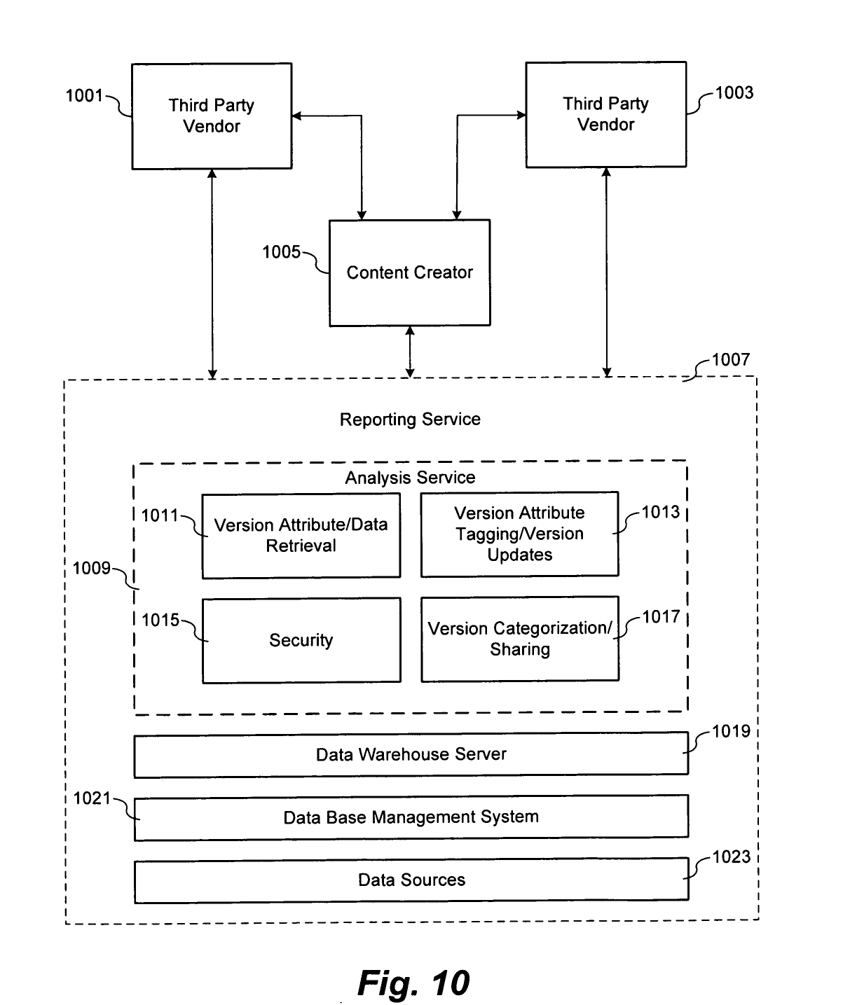

FIG. 10 shows the flow of version information from media creators 1005 and 3^{rd} party vendors 1001, 1003 to the S-DVM reporting service 1007. Media creators 1005 and 3^{rd} party vendors 1001, 1003 interact with the S-DVM's reporting service 1007 in order to obtain useful version information. FIG. 10 also shows the architecture of the S-DVM's reporting service 1007, which generally comprises an analysis service 1009, a data warehouse server 1019, a data base management system 1021, and one or more data sources 1023. The S-DVM's reporting service layer 1007 is where the media creator 1005 and 3^{rd} party vendors 1001, 1003 can obtain, process, and render version data. The reporting service 1007 also processes reports including: executing queries, evaluating expressions, and generating output formats. It is herein the reporting service layer 1007 where a report definition is retrieved and is combined with data from the analysis layers 1011-1017 to create a report. A report definition within the S-DVM's reporting service 1007 contains queries, report layout information, and expressions. The analysis service 1009 of the S-DVM's reporting services 1007 limits the scope of the Reporting Service queries, ensuring that the resulting data will fit the query and permit analysis to be conducted without the distraction of extraneous data. These analytical layers 1011-1017 in the S-DVM's reporting service's architecture bears the brunt of the query load when data arrives from the data warehouse server 1009.

FIG. 10 thus shows an exemplary flow chart of S-DVM's reporting system architecture, an architecture that allows media creators and any 3^{rd} party vendors to query, search for, and update data and will help them work collaboratively in the tagging of attributes and the processing of versions/data. In helping to update versions, comprehensively tag versions, and categorize various versions, media creators and 3^{rd} party vendors may significantly influence the quality of reporting that will be delivered to them by the S-DVM's reporting service.

Specifically, FIG. 10 shows the flow of version information from media creators and 3^{rd} party vendors to the S-DVM reporting service. Media creators and 3^{rd} party vendors interact with the S-DVM's reporting service in order to obtain useful version information. FIG. 10 also shows the architecture of the S-DVM's reporting service which consists of a production layer: reporting service, and analytical layer: analysis service, and a data layer: data warehouse server, data base management system, and data sources.

S-DVM's reporting service, which is in the production layer, is where the media creators and 3^{rd} party vendors can obtain, process, and render version data. The reporting service also processes reports including: executing queries, evaluating expressions, and generating output formats. It is here in the reporting service where a report definition is retrieved and is combined with data from the data layer to create a report. A report definition within the production layer contains queries, report layout information, and expressions. A report layout and data are combined, as mentioned previously so that the media creator and any 3^{rd} party vendors can quickly retrieve information or they may direct the reporting service to generate the report into a format that they can use and view more easily.

The analytical layer of the S-DVM's reporting services or the analysis service limits the scope of the reporting service queries, ensuring that the resulting data will fit the query and permit analysis to be conducted without the distraction of extraneous data. The analysis service may also index and use analytical techniques to deliver quick responses and intuitive access. This layer in the S-DVM's reporting services architecture bears the brunt of the query load when data arrives from the data warehouse server into any one of the analysis service's four data marts (i.e., Version Attributes/Data Retrieval 1011, Version Attribute Tagging/Version Updates 1013, Security 1015, or Version Categorization/Sharing 1017.) The analysis service 1009 cleans and transforms the data, determining which data goes into which data mart.

The data layer of the S-DVM's reporting service architecture may also suitably comprise a data warehouse server, a data base management system (DBMS), and one or more data sources. It is the data layer which is the source of the raw, transaction-level data, which move up the ranks from the data source to the DBMS to the data warehouse server in preparation for the analysis service 1009.

Upon receiving the version reports through the S-DVM's reporting services, the media creator and any 3^{rd} party vendors may be presented with a number of reporting options: version report viewing, printed reports, version report exporting, version report modification, version attribute update, version report synchronized sharing, etc. The media creator and any 3^{rd} party vendors may then use the various information they receive from the S-DVM reports to link media versions with their master files and trace the steps that lead back to source leaks.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A computer-implemented method for managing a plurality of versions of a media file downloaded over the Internet, comprising:
scanning the Internet to identify one or more media files having a selected media title;
analyzing relevant information regarding each such identified media file in order to categorize said one or more media file into unique versions;
grouping said unique versions to identify a predetermined number of unique leak sources; and
distributing said grouped unique versions across the Internet to a plurality of remote users for local and efficient access and analysis of same by said predetermined number of unique leak sources.

2. The computer-implemented method according to claim 1, wherein said predetermined number of unique leak sources comprises from about 1 to 10.

3. The computer-implemented method according to claim 2, wherein said predetermined number of unique leak sources comprises from about 4 to 8.

4. A computer-implemented method for managing a plurality of versions of a media file downloaded over the Internet, comprising:
scanning a selected plurality of websites on the Internet to identify one or more media files having a selected media title;
creating a log by capturing a comprehensive plurality of data attributes for each said media file identified as having said selected media title;
parsing each said log of said captured comprehensive plurality of data attributes for each said media file identified as having said selected media title;
inserting said parsed logs as a plurality of records in a data base;
grouping said plurality of records into a plurality of unique versions of content based on a subset of said captured comprehensive plurality of data attributes;
sorting said grouped plurality of records to determine one or more groups having the most records associated therewith;
downloading said one or more groups having the most records associated therewith across the Internet to a plurality of remote users coupled together in an enterprise network;
reviewing said downloaded groups for a plurality of additional unique identifiers;
identifying said downloaded groups which have a predetermined percentage of said plurality of additional unique identifiers; and
synchronizing said identified groups across said plurality of users coupled together in said enterprise network.

5. The computer-implemented method according to claim 4, further comprising outputting reports of said process on a predetermined frequency.

6. The computer-implemented method according to claim 5, wherein said predetermined frequency is selected from the group consisting of hourly, daily, weekly, monthly, and yearly.

7. The computer-implemented method according to claim 4, wherein said plurality of websites comprises file transfer protocol (FTP) websites, hypertext transfer protocol (HTTP) websites, Internet relay chat (IRC) websites, network time protocol (NTP) websites, network news transfer protocol (NNTP) websites, and peer-to-peer (P2P) networks.

8. The computer-implemented method according to claim 4, wherein said downloading step is manually initiated.

9. The computer-implemented method according to claim 4, wherein said downloading step is automatically initiated.

10. The computer-implemented method according to claim 4, wherein said reviewing step further comprises reviewing for digital watermarks.

11. The computer-implemented method according to claim 4, wherein said reviewing step further comprises reviewing for digital fingerprints.

12. The computer-implemented method according to claim 4, wherein said reviewing step further comprises reviewing for digital watermarks and digital fingerprints.
